(19) United States
(12) Patent Application Publication
(10) Pub. No.: US 2014/0254797 A1
(43) Pub. Date: Sep. 11, 2014

(54) Method and filter for erasing hidden data

(71) Applicant: Agnieszka Piotrowska, Stare Babice (PL)

(72) Inventor: Agnieszka Piotrowska, Stare Babice (PL)

(21) Appl. No.: 14/199,786

(22) Filed: Mar. 6, 2014

(30) Foreign Application Priority Data
Mar. 7, 2013 (PL) P.403052

(51) Int. Cl. H04L 29/06

(52) U.S. Cl. CPC H04L 63/0428
USPC 380/255

(57) ABSTRACT

The application refers to a method and a filter of hidden data characterized by the fact that in order to eliminate the hidden data, the data signal is subject to operation of the degradation in a degradation function module.

### BACKGROUND

The subject of the invention is a method and filter for erasing hiding data.

The subject of the application is from the field of steganography, i.e. transmission of data in covert communication channels.

In the art there are plenty of methods for hidden transmission of data. Hidden transmission channels are developed virtually in all layers of the OSI network model, starting from the physical layer, interfering directly with the physical parameters of signal, and ending with datagram layer, which transports the service contents, where hidden data transmission is implemented by using advanced hidden data introduction algorithms.

The Polish patent application PL 384940 describes a method in which the hidden data transmission is initiated with a transmission opening sequence and ended with a transmission closing sequence, and the information is sent from the transmitting station after an additional delay.

For instance, EP 1645058 A2 reveals a system of hiding data in audio transmission channels with phase modulation. The audio signal is divided into time frames. Relative phases of one or more frequency bands are shifted in each frame, and each shift represents embedded hidden data. In one example, two frequency bands are selected according to a pseudorandom sequence and then their relative phase is shifted.

The document U.S. Pat. No. 6,845,360 B2 describes systems and methods of embedding and extraction of plenty of messages in audio data. Each message contains a sequence of message symbols each comprising a combination of single-frequency components. At least some of the message symbols in one of the messages coexist with at least some of the symbols of another one of the messages along a time base of the audio data.

In the art there are series of methods to detect the presence of hidden transmission, however, in response to the attempts of detection, the development works aim at better hiding data transmission and masking the covert transmission channel.

Known solutions protecting against the use of hidden data transmission erase the hidden data, and are based on the fact of knowing the hidden data type or the data hiding algorithm. For instance, the patent application US 2007/0174766 A1 presents a method of hidden document data removal. The solution is based on a pre-defined configuration the which contains a set of rules and an inspection module which scans is the in search of sequences which correspond to the pre-defined rules, attempting to find a pre-defined data hidden with a method of comparing sequences.

However, the securing solutions based on the paradigm of knowing hidden data or data hiding algorithm face the obvious problem of plentifulness of possible steganographic algorithms. Furthermore, assuming that it is required to know the data hiding algorithm to secure the transmission channel means that the protection solutions will always be susceptible to the latest solutions and types of attacks for which the data embedding algorithm has not been yet discovered by the defending side.

However, having compared the known methods we can see some regularities. The first group of the methods includes employing unused header fields in network protocols. It is the easiest to implement but also the easiest to detect and filter out. Simple methods based on the use of fields such as ‘Padding’, ‘Type of Service’ in the IP header or the ‘Reserved’ field in the TCP header are described by S. Murdoch and S. Lewis in “Embedding covert channels into TCP/IP”. There are also solutions which create its own custom types of packets or frames to send hidden information. One such solution was described by Z. Piotrowski, K. Sawicki, M. Bednarczyk and P. Gajewski in their paper “New Hidden and Secure Data Transmission Method Proposal for Military IEEE 802.11 Networks”.

The second group, using modification of used fields in network protocols, includes more complicated methods. Since the information is hidden in used fields, it is necessary to ensure that once the information is hidden the protocol continues to function properly (inserted values must be correct from the point of view of the protocol). This often limits the throughput of the covert channel created in this manner. An example of such a covert channel is the one implemented using ‘Time to Live’ field in the IP header, as described in U.S. Pat. No. 7,415,018B2. Appropriate modification of fields makes it possible to send hidden messages in a way that does not interfere with the operation of the IP protocol. Another example is the use of the ‘Timestamp’ field in Beacon frames in wireless networks using the IEEE 802.11 standard, as described by K. Sawicki and Z. Piotrowski in the paper “The proposal of IEEE 802.11 network access point authentication mechanism using a covert channel”. In that solution, modification of the least significant bits of the ‘Timestamp’ field allows for transmission of hidden message and also does not interfere with the functioning of a is wireless network. A model example of the use of some IEEE 802.11 frame fields and its practical application was described by L. Frikh, Z. Trabelsi and W. El-Hajj in “Implementation of a Covert Channel in the 802.11 Header”.

In some cases hidden data may be transmitted through modifications made to used header fields by damaging them on purpose. A typical system of that kind was described by K. Szczypiorski in the paper “HICCUPS Hidden communication system for corrupted networks”. It transmits data in IEEE 802.11 network frames with a deliberately corrupted checksum. A broad description of similar solutions has been presented by S. Li and A. Ephremides in the paper “Covert channels in ad-hoc wireless networks”.

The third group of methods uses intentional delay of sending or receiving of frame, datagram or packet, which allows transmission of hidden information through modification of time dependencies. A typical system of that kind was described by R. Holloway, R. Beyah in “Covert DCF: A DCF-Based Covert Timing Channel in 802.11 Networks”. The hidden information is transmitted by selecting an appropriate value of the ‘Backoff’ time chosen for each frame transmitted over a Wi-Fi network. This way, through intentionally delaying or accelerating the transmission of frames, it is possible to create a covert channel. A wide description of the methods is provided in the paper “TCP/IP timing channels: Theory to implementation” by S. H. Sellke, C. C. Wang, S. Bagchi and N. Shroff.

The fourth group are the methods which are based on intentional retransmissions or deliberate loss of transmitted data. A typical example of such a solution is the system described by W. Mazurczyk, M. Smolarczyk and K. Szczypiorski in the paper “Hiding information in re-transmissions”.

In the art, detection of hidden transmission was widely described by S. Cabuk, C. E. Brodley and C. S. Shields in the paper “IP covert channel detection”. The methods are considered to have 95% efficiency. Patented methods of detection of hidden transmissions are also available (U.S. Pat. No. 7,920,705B1). Such solutions require the use of advanced and continuously updated methods of analysis of the transmitted data. Furthermore, they do not guarantee detection of hidden channels created using the latest algorithms.

The solution to this problem may be to use the network steganography filter according to the invention.

The solutions of the patent art also include the watermarking technique which is a is dynamically developing method of protection copyrights in media (both sound, images, movies or 3D objects), using signal processing to hide additional invisible information. Current solutions of the patent art do not raise the issue of erasing hidden data in a way which enables to reinstate the watermarked signal into the original signal. Current watermarking solutions focus on the resistance of the method—securing it against eliminating the additional information, failing to take into account the aspect of concurrent degrading the quality and form of the watermarked image.

In the art we cannot find a solution which would solely refer to the reverse process, i.e. the process of securing against the hidden data transmission. Furthermore, there is a need to introduce a method which would demonstrate equal efficiency in relation to the known algorithms of hiding covert transmission and be efficient as regards future methods of implementing data transmission in covert transmission channels.

### SUMMARY OF THE INVENTION

The object of the invention is a method of filtering in telecommunication systems characterized by the fact that the signal in the packet communications channel is subject to normalization through restoration of default transport frame value, thus eliminating hidden data.

Furthermore, the method of the invention is characterized by the fact that normalization is implemented in relation to data in frame headers of the signal stream in the telecommunications channel.

In addition, the method of the invention is characterized by the fact that normalization is implemented in relation to checksums of frames through their re-calculation according to individual hash function.

Also, the method of the invention is characterized by the fact that normalization is implemented for at least one of the OSI model layers, preferably for all layers, and normalization process is controlled to ensure buffering to adjust delays between frames.

Further, the method of the invention is characterized by the fact that normalization is implemented for at least one frame, preferably for each frame of signal in the telecommunications channel.

Also, the method of the invention is that the signal in the telecommunications is channel in the physical layer is subject to time-normalization through buffering and sending packets with uniform delay.

Further, the essence of the invention is the filter for telecommunication systems which contains a module adopted for normalizing the signal in the packet telecommunications link through inversing default values of the transport frame and eliminating hidden data.

Also, the invention filter is adjusted to normalize data in the headers of the signal stream frames in the telecommunications link.

In addition, the invention filter is adjusted to normalize checksums of frames through their re-calculation according to individual hash function.

Furthermore, the filter of the invention is adjusted to normalize at least one of the OSI model layers, which is beneficial for all layers, however, the filter is adjusted to control the normalization process in order to ensure buffering to adjust delays between frames.

Further, the filter of the invention is adjusted to normalize at least one frame, which is beneficial for each signal frame in the telecommunications link.

Furthermore, the filter of the invention is adjusted to implement time-normalization of the signal in the telecommunications link through buffering and sending packets with uniform delay.

Furthermore, the essence of the invention is the method of filtering hidden data by the filter, in order to eliminate the hidden data, in which the signal is subject to operation of the degradation function module.

Furthermore, the method of the invention is that the degradation function is a complex function and the module implementing the degradation function is made up of a cascade of subunits implementing individual components of the degradation function.

Further, the method of the invention is that the degradation function is parameterized in order to obtain an adjusted level of data signal degradation.

Further, the method of the invention is that the degradation function is parameterized in order to obtain minimum signal degradation.

Further, the method of the invention is that the data signal is speech signal, particularly the one sent over a telephone line.

In addition, the substance of the invention is the hidden data filter which contains a module adjusted to implement the degradation function on the data signal in order to eliminate the hidden data.

Furthermore, the filter of the invention is characterized by the fact that the module implementing the degradation function is made up of a cascade of subunits implementing individual components of the degradation function.

Further, the filter of the invention is characterized by the fact that the module implementing the degradation function is built in such a way that the degradation function is parameterized to obtain an adjusted level of data signal degradation.

Further, the filter of the invention is characterized by the fact that the module implementing the degradation function is built in such a way that the degradation function is parameterized to obtain minimum level of signal degradation.

Furthermore, the method of the invention is that the module implementing the degradation function is built in such a way that it converts the speech signal, including in particular the one sent over telephone lines.

The advantage of the invention is introducing an efficient method of blocking covert data transmission channels irrespective of the applied method of embedding a covert data transmission channel into covert channels and irrespective of the method of packet protocol. The invention may be used on any transmission channel which uses packets as transport units. The invention enhances security of transmission in telecommunication networks and due to its universal application it may be used in multicast networks.

### DESCRIPTION OF THE DRAWING

The subject of the invention is presented in more detail, in a preferred embodiment in drawings of which:

FIG. 1 shows the normalization module, as described in the invention, of a single layer of packet protocol.

FIG. 2a shows the cascade normalization unit of many layers of packet protocol, as described in the invention.

FIG. 2b shows the sequence of normalization of layers in a cascade normalization unit of many layers, as described in the invention.

FIG. 3 shows the module of multimedia filter, as described in the invention;

FIG. 4 shows the cascade structure of the degradation multimedia filter, as described in the invention.

### DETAILED DESCRIPTION

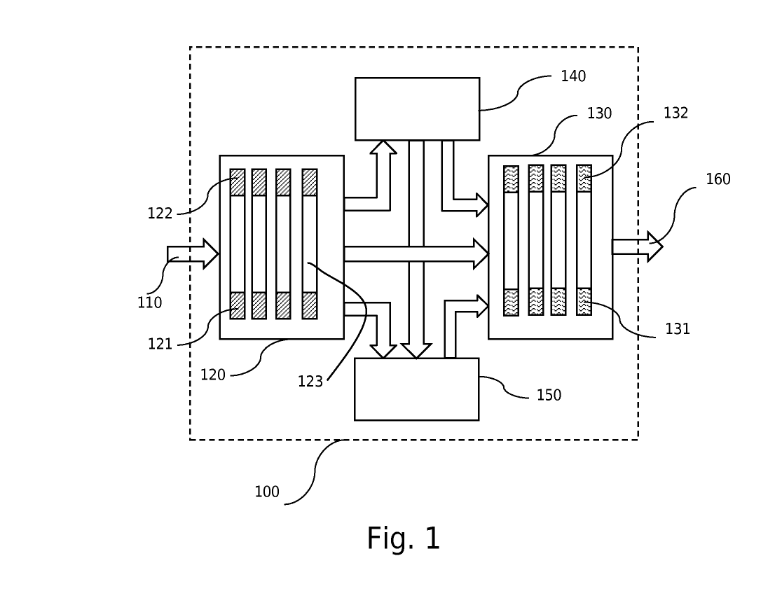

FIG. 1 shows the normalization module 100 of a single layer of packet protocol. The normalization module receives the input stream 110 made up of successive frames. The input stream is then transmitted to the separating module 120 which separates the header 122, the data field 123 and the frame end field 121 from the frame.

The header 122 separated in module 120 and/or the original frame received at the input are transmitted to the module 140 of the header normalization. In that module the header fields are restored to normalized values, i.e. either default values or values restored pursuant to the principles for a given layer of packet protocol.

The final frame field 121, separated in the module 120, and/or the original data field received at the input of the separating module 120 are sent to the module 150 of the final frame field normalization. Normalized header 132 is also sent to that module. In that module the final fields are restored to normalized values, i.e. either default values or values restored pursuant to the principles for a given layer of packet protocol. Particularly when final fields for a given layer of protocol contain checksums which are re-calculated for re-constructed frame.

The data field 123 separated in the module 120 is transmitted to the restoration module 130.

In the restoration module 130 the normalized header 132 and the normalized final frame field 131 are added to the data field 123.

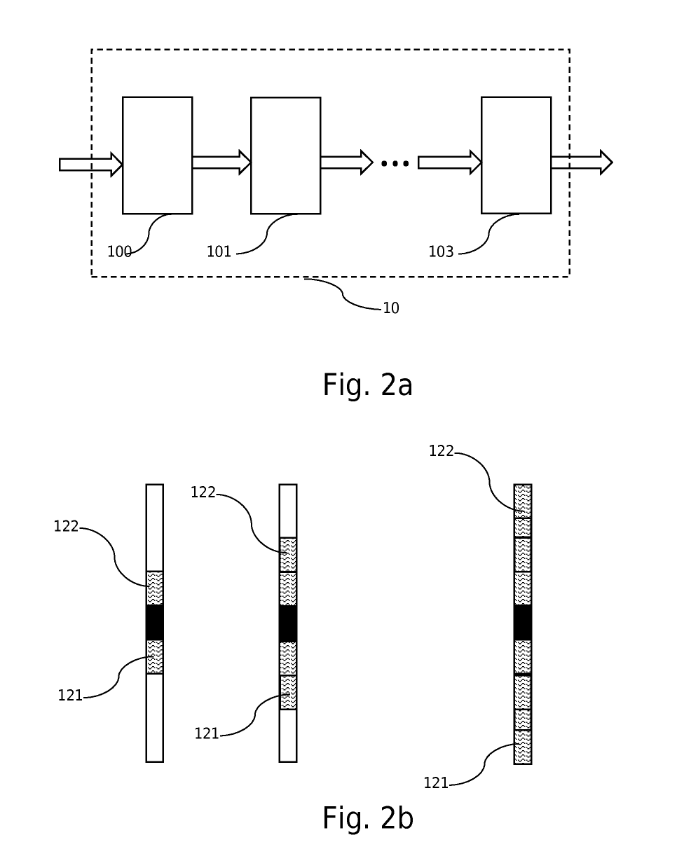

FIG. 2a shows cascade unit 10 of normalization of many layers of packet protocol, as described in the invention. The unit 10 includes a cascade of normalization modules (100, 101, 102) of a single packet protocol layer, such as the one presented in FIG. 1 above. Each module in unit 10 deals with normalization on a corresponding protocol layer. The number of normalization modules in a cascade may be freely selected depending on the needs as regards filtering of hidden transmission and acceptable delay caused by normalization.

It is worth noting here, that if the normalization also covers the normalization of final frame fields of a given layer, through re-calculation of checksums, then normalization shall be implemented first in relation to the layers which are embedded deepest, i.e. the highest layers of the OSI model covered by normalization.

FIG. 2b shows the sequence of normalization of layers in a cascade normalization unit of many layers, as described in the invention. It is visible that the normalization process in the cascade shown in FIG. 2a begins with the internal layers which are embedded deepest.

The filter of the invention may be used in many ways, including in particular placing the filter in devices such as a switch or a router, in the form of software and hardware modules. Software modules operating on higher layers of the OSI model have limited range depending on the configuration of the steganographic system, for instance when connection is established in point-to-point mode, without any intermediate devices. However, in a situation when we can interfere with the devices working in the lowest layer of the ISO/OSI models—in the physical layer, the filter may be also used there as well as the method of the present invention. This refers particularly to wireless networks such as Wi-Fi networks working in ad-hoc mode when the wireless transmission is realized directly from transmitter to receiver.

Likewise, also the methods operating on the second layer of the ISO/OSI model—data link layer, may be filtered out that way.

As a consequence, the second possible way of using the filter of the invention, with access to the physical layer hardware, is building it into the final device (e.g. in a computer or a cellphone). Locating the filter of the invention in a module dealing with the receipt and transmission of data (e.g. in a network interface card) will enable filtering out hidden data before transmitting them to the operating system. There are no obstacles to implement the filter and the method of the invention on all or selected layers of the OSI model.

Furthermore, the normalization modules of the filter of the invention may implement simple normalization, for example, resetting the header fields values or the final frame fields, but also complex normalization, including the adaptation normalization or normalization including tracing of introduced modifications with use of change logs.

The example of such a function introduced for the normalization module 140 is normalization of the ‘Sequence number’ field in the TCP header. The filter must change that value so that the TCP transmission is successful. In the event that the modified value may occur in the future, a change log should be maintained where the information concerning the assignment of modified values will be stored.

Furthermore, the normalization modules 140 of the filter of the invention may be provided with additional functions allowing for broadening the area of filtration through implementing normalization of high degree of advancement, enabling to adjust the filter to a specific new type of steganographic transmission.

Further, the filter of the invention may also introduce adjustments of duration of the normalization and buffering of frames, thus affecting the delays occurring between subsequent frames, which enables eliminating the covert channel implemented with use of methods basing on time dependencies. For instance, in the event of methods based on intentional introduction of delays, the filter controls the normalization process in such a way that it randomly delays some frames or packets, or even modifies their sequence at random.

The filter of the invention may be also enhanced by an option of random losing or retransmission or frames, which introduces a disturbance to covert channel of data transmission and, therefore, greatly hinders or precludes the functioning of methods based on introduction of intentional retransmissions, delays and lost packets, by introducing normalized noise level.

The individual methods of normalization may be adjusted to the protocol of the covert channel and the filtration methods repository itself may be replaced or updated as necessary.

The effect obtained at the filter output thanks to normalization of fields is a uniform stream of data, normalized in time and space.

Thus, the filter of the invention can be an integral component of network and firewall hardware with Unified Threat Management Systems, as well as Intrusion Prevention Systems to enhance the real-time intrusion prevention efficiency. Filters of the invention may be also used in devices such as network switches, routers, network interface cards, which prevents from establishing and using hidden data transmissions on all layers of the OSI network model.

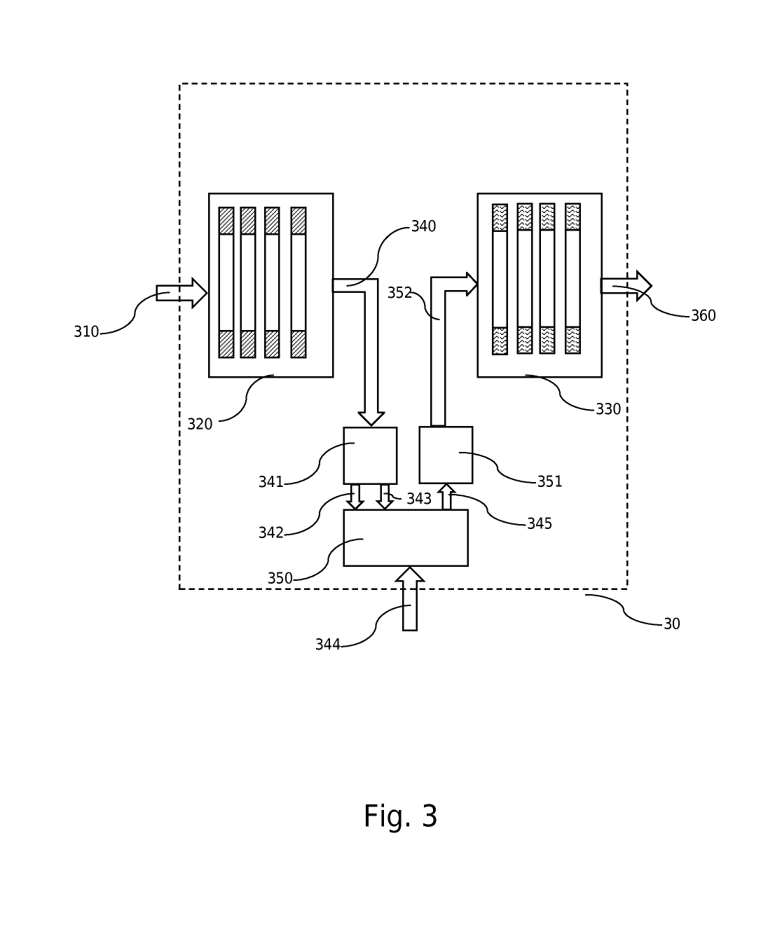

FIG. 3 shows a multimedia filter of the invention used to eliminate hidden is transmission in the data contents sent over an overt transmission link. The input stream 310 is captured by the module 320 which purpose is to separate the service data 340 from the transport stream. The separated service data 340 are transmitted to the formatting buffer which purpose is to recognize and format the service data to enable their identification and recognition of data type. Optionally, the buffer 341 may also combine individual fragments of service data in order to filter out the hidden transmission spread between individual fragments of service data.

The formatted service data 342, including the additional information concerning the format properties 343, are transmitted to the degradation unit 350. On the basis of format properties data 343 (e.g. vector r) the degradation unit selects a degradation function and, based on the settings 344 (e.g. vector q) set by the user or set to default by the filter designer, the process of degradation of service data is implemented.

The degradation process is implemented in such a way that deterioration of service data quality does not have too adverse impact upon their receipt and use, so that the final user cannot distinguish the original transmission from the filtered one. It means that the method and filter of the invention will find application mostly to eliminate hidden transmission in multimedia transmissions received by final users through senses.

At the output of the degradation unit 350 the filtered service data are transmitted to the module which converts service data into a form which is suitable for embedding in the transport stream, for instance by dividing the filtered service data 345 into individual datagrams. The service data adjusted to the parameters of transmission link are then embedded in the transmission link in module 330 and transferred in the form of filtered data stream 360.

It is worth noting here that the covert transmission filters presented in FIGS. 1 and 3 do not detect the covert transmission nor check whether covert transmission was embedded in frames or service data. It is assumed that all frames and service data passing through the filter are filtered—thus, it is a blind filtration. However, tests revealed that implementing blind filtration provides statistically better effects than active filtration which utilizes recognition of hidden data embedding algorithm. Obviously, knowing the data hiding algorithm allows to obtain 100% efficient filtration, however, in practical applications, obtaining such efficiency is not required, is since the disturbance introduced by the blind filter of the invention efficiently eliminates ca. 90% of characters transmitted in covert channels, which makes it virtually impossible to reproduce the message by the receiver.

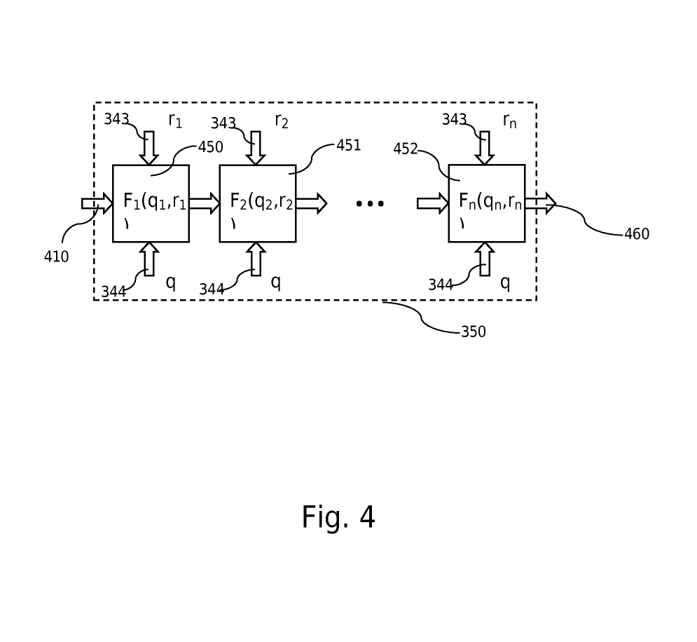

FIG. 4 shows the cascade of degradation functions 450, 451, 452 which process the service data 410 (in FIG. 3 the data are marked as 342), depending on the vector q of the settings 344 as set by a user or the system designer. In FIG. 4 the components of vector q of settings 344 were assigned to individual functions in the cascade. The cascade of degradation functions 450, 451, 452 is parameterized also by vector r which represents data concerning the service data format information 410, the format information, which form vector r, are marked as 343 in FIGS. 3 and 4, and individual components were assigned to individual functions in the cascade.

It is worth noting here that the presented cascade of degradation functions is only an example of how the invention may be developed. It is considered that also the multi-dimensional structures will be covered by claims. Also the presentation of formatted service data 342, format data, vectors 343 and the data concerning settings 344 as vectors is only an example of how the invention may be developed and it is considered that the claims also include cases when the data are in multi-dimensional form or a form of other data structures, such as trees, object structures or object tables.

Modular structure of the degradation unit may be developed with use of plug-ins, which may increase the filter efficiency by using new types of degradation functions and broadening the potential of filtering new service data formats.

In the example of development of the invention filter, a filter of covert transmission for images was implemented and its efficiency tested. In the example it was assumed that the covert data will be a watermark in the image.

The watermark disturbance function begins with processing of the watermarked image from RGB representation into YCbCr. Next, a cepstral analysis is performed in order to determine the spatial offset of the added low-energy brightness matrix. To do that, a 2-dimensional Discrete Fourier Transform is performed on the watermarked luminance matrix Y′_{wm}:

$${Y}_{wmDFT}^{′} ( k , l ) = {\sum }_{x = 0}^{X - 1} [ {\sum }_{y = 0}^{Y - 1} {Y}_{wm}^{′} ( x , y ) {b}_{YDFT}^{*} ( l , y ) ] {b}_{XDFT}^{*} ( k , x )$$

$${Y}_{wmXYDFT}^{′} = {B}_{XDFT}^{*} {Y}_{wmXY}^{′} {B}_{YDFT}^{* T}$$

$${b}_{DFT} ( k , x ) = \sqrt{\frac{1}{X}} exp ( j \frac{2 π k}{X} x )$$

$${b}_{DFT} ( l , y ) = \sqrt{\frac{1}{Y}} exp ( j \frac{2 π l}{Y} y )$$

x, y—indexes of discrete spatial positions of pixels,
X, Y—spatial resolution of images,
k, l—indexes of discrete 2D signal spectrum frequency.

Next, the cube of two-dimensional autocepstrum function of the matrix Y′_{wmDFT′} is calculated:

$${Y}_{wmcepst}^{′} ( m , n ) = {( I D F T ( ln ( \vert {Y}_{wmDFT}^{′} ( k , l ) = \vert ) ) )}^{3}$$

$${Y}_{wmIDFT}^{′} ( x , y ) = {\sum }_{x = 0}^{X - 1} [ {\sum }_{y = 0}^{Y - 1} {Y}_{wmDFT}^{′} ( k , l ) {b}_{YDFT} ( l , y ) ] {b}_{XDFT} ( k , x )$$

m, n—indexes of discrete coefficients of two-dimensional autocepstrum matrix.

In the degraded watermarked image, the coordinates of luminance copy offset will correspond to the coordinates of cepstrum coefficient, for which the cube of two-dimensional autocepstrum function will obtain much higher value, due to the copy of its own signal. Next, after crossing the decision threshold τ the coordinates of the cepstrum coefficient Y′_{wm cepst}(m,n) will determine the values of reverse offset of the luminance matrix copy pₓ,p_{y}, and the subtraction or addition sign will be defined by the phase Y′_{wm cepst}(m,n):

:Y′_{c-wm}(x,y)=Y′_{wm}(m,n)±Y′_{wm}(m+pₓ,n+p_{y})δ
δ—watermark energy coefficient.

Then, for such processed luminance matrix of the disturbed watermarked image Yx_{wm} a luminance matrix with eliminated mark Y′_{c-wm}(x,y) is obtained which is the same as is the matrix Y′(x,y). The last step is to transform the matrix from the YCbCr form into RGB notation, which provides a resultant signal O′.

The masking function M_{c-wm} of the filter of the invention has been implemented in practice, its efficiency was tested by using the same base of original images as for the function F_{c-wm}. The efficiency of masking the mark signal was measured as the percentage of eliminated information (the information was undetectable) from the watermarked images (the quantity of degraded original images O′_{deg} in relation to the number of images). The information i included into the watermarked signal O′_{wm}, was generated at random.

| Effect [%] | 81.82 | 99.7 | 98.90 | 97.98 |
|---|---|---|---|---|
| M_{size} | 2 × 2 | 4 × 4 | 4 × 4 | 5 × 5 |
| l | 4 | 6 | 4 | 4 |
| PSNR_{Oryg-Wm} [dB] | 39.31 | 37.18 | 39.36 | 39.27 |
| PSNR_{Oryg-c-wm} [dB] | 32.06 | 34.93 | 35.72 | 36.54 |

Effect—the efficiency of masking the watermark signal, measured as a ratio between the watermark signals eliminated from the watermarked images and the number of all watermarked images, with the condition that the watermarked image was restored to the form of original image.
M_{size}—the dimensions of the matrix of spatial median filter,
l—the offset coefficient of the matrix initiating the PSF search of the coding function of the Wiener blind deconvultion filter,
PSNR_{Oryg-Wm}—PSNR calculated between the original image and the watermarked image,
PSNR_{Oryg-c-wm}—PSNR calculated between the original image and the image restored as a result of using the masking function M_{c-wm}.

Taking into account the quality of the restored original image, l=4 and M_{size}=[4,4] was used in the algorithm, as the most optimum values for the watermark signal is masking method.

The examples of other degradation functions may also include simpler functions, such as modification of the image size or resolution. The examples of the degradation function relate to filtration of service data in the form of audio data, particularly those that represent speech. The examples of degradation functions shall include particularly: lossy compression, sample rate change, changing the resolution of binary data (the so-called requantization), lossy compression for various compression rates, band-pass filtering, band equalization, adding noise of various statistic distributions, cutting out fragments of signal, inserting additional fragments of signal.

1. The method of filtering hidden data by the filter wherein to eliminate hidden data, the data signal is subject to operation of the degradation function module.

2. The method according to claim 1 characterized by the fact that the degradation function is a complex function and the module implementing the degradation function is made up of a cascade of subunits implementing individual components of the degradation function.

3. The method according to claim 1 characterized by the fact that the degradation function is parameterized in order to obtain an adjusted level of data signal degradation.

4. The method according to claim 1 characterized by the fact that the degradation function is parameterized in order to obtain minimum level of data signal degradation.

5. The method according to claim 1 characterized by the fact that the data signal is speech signal, particularly speech signal sent over a telephone line.

6. A hidden data filter containing a module suitable to implement degradation function on the data signal in order to eliminate hidden data.

7. The filter according to claim 6 characterized by the fact that the module implementing the degradation function is made up of a cascade of subunits implementing individual components of the degradation function.

8. The filter according to claim 6 characterized by the fact that the module implementing the degradation function is built in such a way that the degradation function is parameterized to obtain an adjusted level of data signal degradation.

9. The filter according to claim 6 characterized by the fact that the module implementing the degradation function is built in such a way that the degradation function is parameterized to obtain minimum level of data signal degradation.

10. The filter according to claim 6 characterized by the fact that the module implementing the degradation function is built in such a way that it converts the speech signal, including in particular the one sent over telephone lines.
